(19) United States
(12) Patent Application Publication
(10) Pub. No.: US 2006/0155754 A1
(43) Pub. Date: Jul. 13, 2006

(54) Playlist driven automated content transmission and delivery system

(76) Inventors: Steven Lubin, Yardley, PA (US); Theodore M. Sabety, Pleasantville, NY (US)

Correspondence Address: Ted Sabety, 36th Fl., One Penn Plaza, New York, NY, 10119, US

(21) Appl. No.: 11/295,761

(22) Filed: Dec. 7, 2005

Related U.S. Application Data
(60) Provisional application No. 60/634,137, filed on Dec. 8, 2004.

(51) Int. Cl. G06F 17/00; G06F 7/00

(52) U.S. Cl. 707/102

(57) ABSTRACT

A media content playlist generating system where data derived from detected public performances or purchases of music is stored in a database and users can query the database, where the query result becomes a playlist that causes the music in the playlist to be transmitted or otherwise delivered to the user.

This application claims priority to U.S. Pat. App. No. 60/634,137, filed Dec. 7, 2004.

### BACKGROUND AND SUMMARY OF THE INVENTION

Several services collect data regarding sales or plays of music or other content items. For example, Mediaguide™ detects what music, advertising or television programming is played by a given broadcaster and collects this information into its database. Other companies, like Nielsen, Mediabase and Audible Magic have similar systems that collect such data. In addition, companies like SoundScan automatically measure what sound recordings are purchased, including the time, date and location. All of this data can be used to drive a novel kind of quasi-interactive programming of digitally delivered content by means of the invention. The data can be organized and stored in a database so that a user can query the database and have whatever songs whose characteristics meet the requirements of the query queued up for playback or delivery to the user using commonly known digital music delivery systems, in one embodiment, streaming over the internet and in another, downloading over the internet.

### SUMMARY OF THE INVENTION

The invention is a system comprising a computer system, communications network, and database. The database is housed in any kind of typical memory device, including, without limitation, a hard drive in a computer server. The database has two components: content items, which can include sound recordings or other audiovisual recordings in digital form, whereby each content item has some kind of indicia of identity like a reference number, including title, and the database has a list of playlists, where a playlist is associated with a particular radio station or other electronic media source or particular store selling music or movies, including by means of a UPC code or other unique fulfillment identifier. The playlist lists what song or other content item was played and when for the associated broadcast station. Similarly, the playlist can include what content items were sold or selected for play or delivery from other types of digital media sources. The list can also include genre or format type for that electronic media source. By electronic media source, it is meant a broad range of sources, ranging from radio station, television stations, cable televisions stations, cable television based radio, satellite radio, satellite television, internet websites that operate like radio or television stations, record stores, video rental stores, on-line versions of record stores or video rental stores or any other means that content items are distributed to the public.

The digital data representing the playlists or sales lists of a range of content is stored in a database or in a plurality of databases and is accessible by the system. In another embodiment, the play times and stations or websites performing a song are stored, and playlists generated by means of database queries to the database. In yet another embodiment, the sound recordings are housed in a separate database with cross reference indexing so that data results from the play list database can be used to reference specific sound recordings in the sound recording database. The system is also accessible by the user, who can log-in or otherwise access the system by means of a web-page interface on the computer. Alternatively, audio or audio-visual appliances, such as mobile phones, hand-held digital media players, for example, the i-POD™, can be designed to have specific buttons, displays or similar actuators that provide the interactivity with the system.

### BRIEF DESCRIPTION OF THE DRAWINGS

FIG. 1. A system level architectural layout of the system.

### DETAILED DESCRIPTION OF THE PREFERRED EMBODIMENTS

The user may input into the system certain criteria that is used to filter the data stored in the databases. This would be by means of creating a query in the database or databases with specific attributes selected by the user. The playlist would essentially be the result of the database query. For example, the user might select a particular geographic location or criteria in order to hear music that has been recently playing in a particular city. Any other attribute that are collected in the database may be used to further filter the results: for example, dates, genres, radio or television station identifier, can be used. Thus, the user might also select all songs played by college radio stations in Massachusetts last year. Practitioners of ordinary skill will recognize that the criteria can be very narrow, for example, the current playlist from a specific radio station, or stated as a range: the top 25 songs played on radio stations in California, or the top 25 songs songs played by a specific radio station last month. In addition, the filter can include frequency of play, so that the user can be limited to those songs in the “top ten” (or any other type of desired ranking) rotation across the college radio stations in the United States. Of course, this system can include data and playlists from around the world. Any set, subset or combination of attributes can be used to create a playlist for the user. As the sources of the data are updated, the filters can be re-run periodically or continuously and the playlists automatically updated, even during playback. For example, if a user has specified the top 25 songs in rotation in some period in college radio across the U.S., if a new song is played 25 times in the same period, the playlist is automatically updated to include the new song. The system can be designed so that as soon as that new song enters the playlist, it is cued up as the next song to transmit. In another embodiment, the user can create database queries of their own that create unique playlist results, for example, all songs whose titles contain the word “kiss.”

Once the playlist is determined, the system will then call up from a second database comprised of sound recordings with an appropriate index, each of the songs corresponding to the playlist. The user can also set criteria to determine in what order the songs are played: popularity in the filter, or alphabetic by artists, song title, or sequentially based on when the song was played or sold. Once the playlist is so determined, the system can then perform the music, transmitting a signal to the user whereby they can listen to the playlist. Alternatively, the system can download a file or set of files that contain sound recordings, either the exact set so recovered or other versions. The same functionality can apply to the audiovisual recordings as well. With the iPod™ the system can create a single sound recording comprising a series of sound recordings, known in the field as a “podcast.”

In one embodiment, the playlist filter has been determined, it can be saved by the user so that the user can select from among their own custom created filters. Alternatively, the system can provide a wide variety of pre-created filters that can be further customized, if the user desires to.

One aspect of the system is that once the playlist filter is determined for a specific user, the system can respond in real time. Thus, if a new song or program has been registered in the database, it can be immediately inserted into the user's playlist so that the user does not have to submit the filter again to hear the new music that meets the test of the filter.

Other sources of playlist data include delivery data recovered from peer to peer file sharing networks or music downloading websites. Additionally, sales data from stores that sell or rent CD's or DVD's or any other solid media can be used.

The system can also support a membership whereby members can characterize their electronic media content tastes, and then the filter can be applied to the content items the subscribers are purchasing, downloading or otherwise listening to or viewing. For example, the system would include a client-side audio player that interfaces with popular music websites. As music is purchased or downloaded, the client can anonymously upload the identity of selections to the system, which then alerts other client-side installations that a new song that fits a particular filter has been selected. This way, leaders of musical taste can automatically cause other members of the group to hear what they are buying or listening to. In addition, this playlist data can be available to the database so that a user can request a playlist based on that data. For example, the user may request the top 10 most played songs that are listened to by a particular group of listeners who are characterized as preferring some obscure genre. Users can be members of multiple groups.

The system is comprised of software running on at least one computer connected to a digital communications network, for example, the Internet. The system and software is operatively connected to appliances or personal computers that operate software and/or hardware render the data into musical sounds perceptible by the user, as well as providing interactivity, or cause and response on the user interface of the appliance or personal computer. In addition, the system is operatively connected through one or more digital networks to the databases housing the playlists, for example, by using XML queries to these data sources.

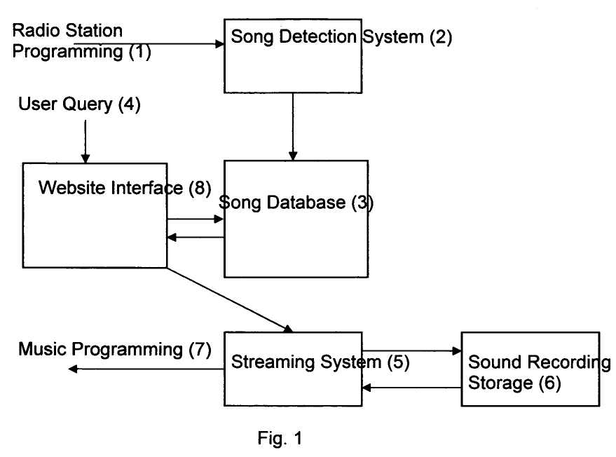

Referring to FIG. 1, the database is populated by detecting radio station programming (1) using the song detection system (2). Reference is made to PCT/US2005/004802 where song detection and databases are presented. The song detection system populates the database (3). The user (4) interacts with the system using a computer interface, which, in the preferred embodiment, is an internet website (8). The user formulates a query which is sent by the website (4) to the database (3). The result is passed back to the website (8) and a playlist formulated. The playlist is then sent to the streaming system (5) which sets up the delivery of the music by means of accessing sound recordings in a storage system comprising digital copies of sound recordings (6). The sound recordings are streamed to the user in sequence. (7)

Although some specific aspects have been described in terms of musical works, the same invention can apply for the selection and playback of audio-visual works.

In a specific embodiment of the invention, a user operates a personal computer, running, for example Windows™ and the client software. The selection of operating system and personal computer or other user device is arbitrary, so long as the client software is operating to provide the user interactivity by means of keyboard, mouse, screen and loudspeakers or types of devices that provide button, switch or selection actuation, display and audio or audio-visual output. The user inputs into the user interface (or selects from pre-selected criteria) certain criteria of the playlist of interest. For example, the user might desire to listen to the most popular college radio programming in and around Boston over the last week. This query is compiled into a message that is sent over the internet to the server side. The server operates software that takes account of the IP address of the client, and then further transmits a query, which may be an XML formatted message, to a database that has all of the current playlists in the U.S., including the Boston area. The database then returns the identity of all songs played in the last week on radio stations categorized as college radio stations located in the Boston area. The server then selects the most frequently played songs. This may be as a result of a number provided by the user (e.g. the top 50) or arbitrarily selected by the system. Once the selection is made, the server then accesses the database of sound-recordings and requests that the sound-recordings begin transmission to the client software at the referenced IP address. Alternatively, the server can send a message to another transmission system indicating the desired playlist and the IP location of the client software, and the additional broadcast system can provide the transmission without further control from the server. Practitioners of ordinary skill will recognize that the database that houses the data indicating radio station, song, playtime, may not have all of the criteria. Instead, the invention's server can access a distinct database that cross references the identity of radio stations with genre or geographic location or metropolitan area. Because radio stations often change genre, the database can include dates associated with a genre. In this case, the invention would search that database to determine which radio stations fit the criteria set by the user, for example, all college radio stations associated with the Boston area. Then, the server can submit one or more queries to the database containing the playlists to extract the playlists of the radio stations individually, and then compile the complete playlist that the user desires.

Practitioners of ordinary skill will also recognize that the invention can also tie purchase of the sound recording to its performance as follows. When the user is listening to the series of sound recordings that are being transmitted in the manner of a public performance, the client software can keep track of the entire playlist and which song is currently playing. Should the user desire to purchase a copy of the sound recording, then the user can either review the entire play list and select by means of the user interface, which song to purchase by selecting the title, or, while the song is playing, to click on an area of the user interface that indicates to the software the desire to purchase the currently playing song. In either case, the invention can transmit the purchase selection back to the server side, whereupon a purchase transaction can be initiated in a variety of well known ways. In addition, the system can initiate a purchase of the content items prior to their transmission.

The user may also want to store various playlists that have been selected by means of the invention. In that case, the user can save such playlists to a file, which can also contain the query itself for future reference. Should the user desire to re-hear a playlist, then the invention permits the client side software to load the file representing the playlist and transmit to the server the list, or alternatively, the query, whereby the server re-creates the playlist. The latter might be used to save communication bandwidth from the user to the client. The invention then initiates the performance of the program as before. Alternatively, the invention on the server side can save the playlist and reference in the file the identity of the user. This way, the user can select an “old” playlist and the server already possesses a copy of the list. If the user has purchased the sound recordings or other content items, then the entire function regarding playback of past playlists can reside in the user's device.

Practitioners of ordinary skill will recognize that the copyright licensing aspects of the invention change the economic aspects of the system. For example, if the system delivers downloads to the user's device, then the operators of the system may have to pay per-copy royalties for the underlying song as well as per-copy royalties for the sound recording. In addition, it may be that the sound recording license may be unobtainable. On the other hand, if the operation of the system meets the statutory licensing requirements of 17 U.S.C. §114, the text of which is incorporated herein by reference, then the system operator may apply for a statutory license. In particular, if the playlists that are assembled by the invention fail to meet the requirements of §114(d)(2), then the playlist can be arbitrarily extended to meet these statutory requirements. For example, the statute expressly sets out the requirement that for a statutory license, the playback must be no greater than the sound recording performance complement. Therefore, the playlist that is generated can be padded, or extended to include content items that make the entire playlist meet the specifications of the sound recording performance complement or to rearrange the list of songs in the playlist to produce the same result. In addition, the system, to meet these requirements, would not publish or make available to the user the playlist prior to its entire playback, although informing the user of the artists that will be played back via the playlist would be acceptable. In sum, the system can be operated so that the playback of sound recordings occurs in a manner that meets the requirements of 17 U.S.C. §114 (d)(2)(C).

The described embodiments of the invention are intended to be exemplary and numerous variations and modifications will be apparent to those skilled in the art. All such variations and modifications are intended to be within the scope of the present invention as defined in the appended claims. Although the present invention has been described and illustrated in detail, it is to be clearly understood that the same is by way of illustration and example only, and is not to be taken by way of limitation. It is appreciated that various features of the invention which are, for clarity, described in the context of separate embodiments may also be provided in combination in a single embodiment. Conversely, various features of the invention which are, for brevity, described in the context of a single embodiment may also be provided separately or in any suitable combination. It is appreciated that the particular embodiment described in the Appendices is intended only to provide an extremely detailed disclosure of the present invention and is not intended to be limiting. It is appreciated that any of the software components of the present invention may, if desired, be implemented in ROM (read-only memory) form. The software components may, generally, be implemented in hardware, if desired, using conventional techniques.

The spirit and scope of the present invention are to be limited only by the terms of the appended claims.

What is claimed:

1. A playlist generation system comprising:
A database containing a list of content items that has been either publicly performed by or delivered as copies from at least one electronic media source, whereby the identity of the content item is cross-referenced to at least one of: identity of the source, approximate time of performance or delivery of the content item, approximate geographic location of the source, genre associated with the source, genre associated with the content item, performing artist, songwriter, director, screenwriter;
A system that takes as input a request for the identity of or reference to at least one content item that meets criteria specified by a user through the user's device user interface, including at least one of identity of the source, range of time of performance or delivery of the content item, range of geographic location of the source, genre associated with the source, genre associated with the content item, performing artist, songwriter, director, screenwriter and submits to the database a query that is derived from such request which returns a playlist or list of references that reference the at least one content item that substantially meets the specified criteria;

2. The system of claim 1 further comprising:
A playback system that takes the playlist as input and either transmits at least one of the content items referenced by the playlist in the manner of a public performance or causes delivery of a copy of at least one of the content items.

3. The system of claim 1 where the transmission sources include: terrestrial broadcast radio stations, terrestrial broadcast television stations, cable television, satellite radio, internet radio, internet television, record stores selling Compact Disks, websites selling downloads of either music or audiovisual works, peer-to-peer systems providing access to transmissions of sound recordings or audiovisual works, website selling DVD's, stores selling DVD's, services renting DVD's, websites that stream audio, websites that stream audiovisual works.

4. The system of claim 1 where the at least one of the content items is one of: sound recording, audiovisual work.

5. A method of generating a playlist referencing at least one content item comprising:
Receiving from a user's device at least one criteria of selection;
Generating a database request using the criteria of selection;
Receiving from the database a list of content items that substantially meet the requirements of the criteria of selection.

6. A method of operating a digital media transmission system comprising:
Receiving from a user's device at least one criteria of selection;
Generating a database request using at least one of the criteria of selection;
Receiving from the database a list of at least one content item that substantially meets the requirements of the criteria of selection;
Transmitting to the user's device at least one of the content items.

7. The method of claims 5 where the criteria of selection is one of: identity of the source, range of time of performance or delivery of the content item, range of geographic location of the source, genre associated with the source, genre associated with the content item performing artist, songwriter, director, screenwriter.

8. The method of claims 6 where the criteria of selection is one of: identity of the source, range of time of performance or delivery of the content item, range of geographic location of the source, genre associated with the source, genre associated with the content item performing artist, songwriter, director, screenwriter.

9. The method of claim 5 where the playlist is modified to meet the requirements of 17 U.S.C. §114(d)(2)(C).

10. The system of claim 1 where the user interface does not list or save to the user's device the playlist prior to the transmission of the content items referenced by the playlist.

11. The system of claim 5 where the user interface does not list or save to the user's device the playlist prior to the transmission of the content items referenced by the playlist.

12. The system of claim 1 where the user interface does not list the title of a content item that is referenced by the playlist prior to the commencement of such content items' transmission.

13. The system of claim 5 where the user interface does not list the title of a content item that is referenced by the playlist prior to the commencement of such content items' transmission.

14. The system of claim 1 where the user interface lists at least one title of content items that have already been transmitted to the user's device.

15. The system of claims 5 where the user interface lists at least one title of content items that have already been transmitted to the user's device.

16. The method of claim 1 where the playlist is modified to meet the requirements of 17 U.S.C. §114(d)(2)(C).

17. The method of claim 1 where the playlist is modified to meet the statutory requirements of public erformance of sound recordings.
